(19) United States
(12) Patent Application Publication
(10) Pub. No.: US 2005/0150975 A1
(43) Pub. Date: Jul. 14, 2005

(54) Vaporizing arrangement for sublimating materials

(76) Inventors: Gunther Klemm, Nidda (DE); Jens Herzog, Seligenstadt (DE); Hans-Georg Lotz, Grundau-Rothenberger (DE)

Correspondence Address: NEEDLE & ROSENBERG, P.C., SUITE 1000, 999 PEACHTREE STREET, ATLANTA, GA, 30309-3915, US

(21) Appl. No.: 11/001,528

(22) Filed: Dec. 1, 2004

(30) Foreign Application Priority Data
Jan. 14, 2004 (DE) 10 2004 001 884.7

(51) Int. Cl. B05B 1/24; F25B 47/00; B05C 5/04

(52) U.S. Cl. 239/82; 239/83

(57) ABSTRACT

The invention relates to a vaporizing arrangement. It preferably should be utilized in vacuum coating systems. The vaporizing arrangement comprises a two-part housing, namely a pan (3) and an associated lid (8), which is provided with the exit slot (16) for the material to be vaporized. Extending transversely above the pan (3) are several heating rods (5) which can be contacted on the outside and the radiant output of which heats the material to be vaporized, for example zinc sulfide, and causes it to vaporize. The arrangement is relatively simply constructed, can be easily disassembled, cleaned, and reassembled and can, if several arrangements of this type are combined, also be used for the uniform coating of very wide films.

This application claims priority benefit of German Application No. 10 2004 001 884.7 filed Jan. 14, 2004, which is hereby incorporated by this reference in its entirety.

### BACKGROUND OF THE INVENTION

### FIELD OF THE INVENTION

The invention relates to a vaporizing arrangement for sublimating materials according to the characterizing clause of Claim 1.

Such a vaporizing arrangement is described in GB 23 39 800 A. The vaporizing arrangement is needed by way of example in vacuum coating systems in order to apply thin layers of a certain material, for example zinc sulfide, to films. Such a vacuum system comprises a receiver which can be evacuated in which there is a relatively long shaft through which the film or film web which is to be coated is brought with the aid of various rollers. The vaporizing arrangement is mounted in this shaft so that the vapor emerging from the vaporizing arrangement can be deposited in thin layers on the film.

The vaporizing arrangement essentially comprises elongated pans for receiving the material to be vaporized and a heating arrangement. The aforementioned GB 23 39 800 in particular provides that the heating arrangement comprises radiant heaters which are arranged below the pan and heat the bottom of the pan and thus indirectly the material to be vaporized and thus cause it to vaporize. Other arrangements provide resistance heaters which are in direct contact with the pan so that the heat is transferred through convection.

Generally the problem is that the vaporizing arrangements must be capable of receiving relatively large quantities of material to be vaporized so that the coating systems can run as long as possible without interruption. On the other hand, cleaning work must be performed on a regular basis since the material to be vaporized not only gets onto the film but also is deposited in other areas of the vaporizing arrangement and the coating apparatus. The vaporizing arrangement therefore must be capable of being relatively easily disassembled and just as easily reassembled after the cleaning. In addition, there must be as uniform a vapor emission rate as possible over the entire width of the film, thus over the length of the vaporizing arrangement, so that the film is coated uniformly.

In order to comply with the above requirements, the invention proposes for a vaporizing arrangement according to the characterizing clause of Claim 1 that the radiant heaters be configured as heating rods which are situated above the pan so that the heat radiated down is directed directly onto the material to be coated which is present in the pan.

In this manner, a high degree of uniformity of radiation of heat can be achieved since the heat distribution cannot be influenced through fluctuations of heat within the pan. In addition, it is specifically the material pieces lying on top in the pan that are heated so that there is no heat loss through the transport of the heat through the bottom and the lower layers of the material present in the pan.

Generally the pan is closed by a lid which has an escape slot for the escape of the vapor.

Since the heating arrangements are situated above the pan but below the lid, they are situated within the housing formed by the pan and the lid. The radiation output of the radiant heaters thus acts directly on the inner side of the lid which prevents the material from being able to sublimate again on its walls.

Typically the pans are significantly longer than wide, whereby in this case several heating rods are arranged transverse to the long axis of the pan.

Furthermore, the heating rods are held on both sides in a support ring of high-temperature ceramic. This allows the pan and the lid itself to be produced from an electrically conductive material and thus one which conducts heat well such as molybdenum, as a result of which the support rings facilitate an electrical insulation of the heating rod with respect to the housing.

For simple assembly, the support rings which are mounted onto the heating rods are laid on the edge of the pan opening. The lid and/or the pan has cutouts at its or their outside walls which encompass the bearing edge so that the housing is completely closed to the exit of vapor up to the exit slot, which in particular causes the vapor to be directed exclusively through the exit slot in the direction of the film. In this manner a good yield is achieved.

The heating rods are somewhat longer than the pan is wide so that they project on both sides of the pan and can be contacted electrically from the outside.

For this purpose the vaporizing space of the coating system has lateral posts with electrical contacts, with at least the posts of one side being capable of being moved transversely so that they can bridge the space from the wall of the vaporizing space to the vaporizing arrangement.

The invention will be explained in greater detail below on the basis of an exemplary embodiment.

### DESCRIPTION OF THE DRAWINGS

FIG. 1 shows an opened coating device with mounted vaporizing arrangement according to the invention,

FIG. 2 shows a vaporizing arrangement with removed lid,

FIG. 3 shows a cross section through a coating system according to FIG. 1.

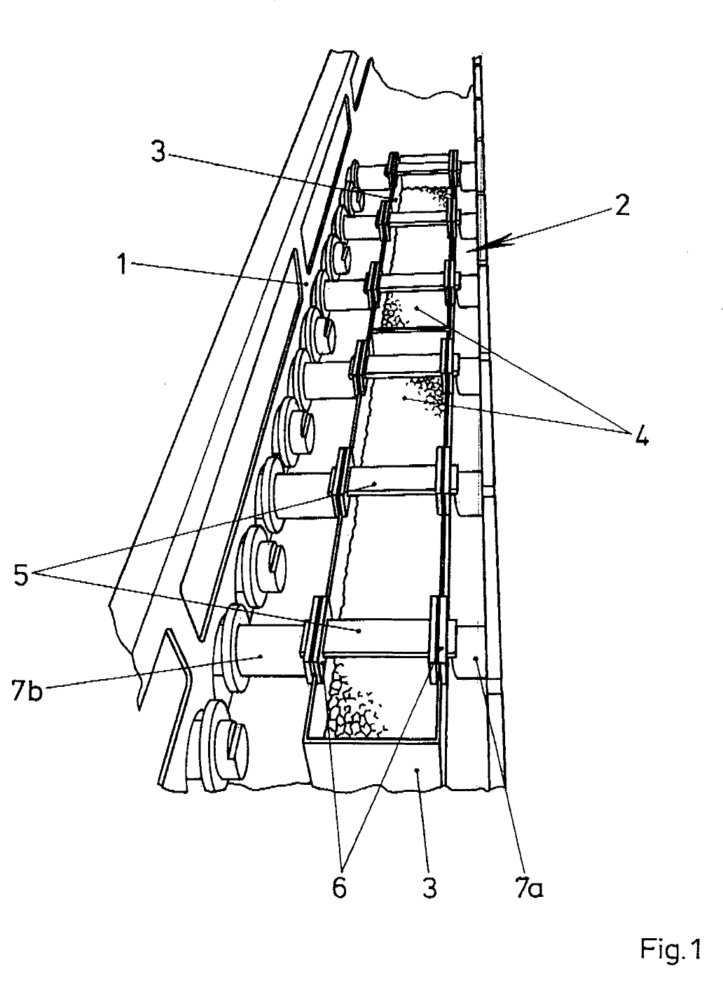

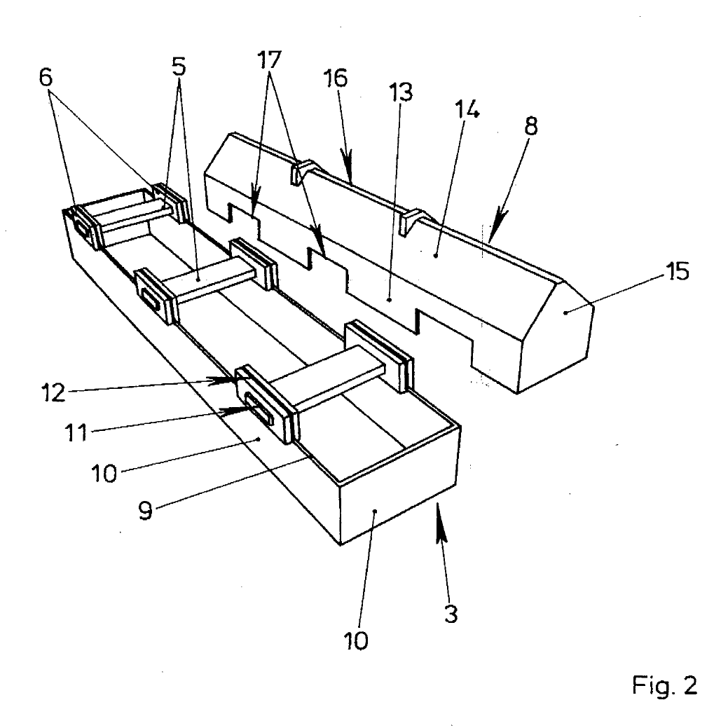

First reference is made to FIG. 1. Vaporizing space 1 can be seen which extents shaft-like over the width of the system. By means of not-depicted rollers, the film to be coated is brought across the opening of the vaporizing space. In vaporizing space 1, a vaporizing arrangement 2 is situated, comprising two oblong pans 3 which abut each other with their short sides. In pans 3 is situated material 4 to be vaporized, in the present case zinc sulfide granulate which is brought into the pan in the form of bulk material. Extending above each pan 3 are two heating rods 5 which are arranged at a uniform distance from each other. They are held by supporting rings 6, with the ends of heating rods 5 projecting laterally over pan 3 and it being possible for them to be contacted with the contact posts 7 projecting out of the walls of the vaporizing space. Pans 3 are closed by means of covers which are not depicted in this figure, but are presented in greater detail in FIG. 2, which shows a pan 3 with associated cover 8 removed to the side for better clarity.

Pan 3 is a rectangular hollow body the upper side of which is completely open so that there is an encompassing rectangular pan rim 9 which is formed by the edges of the short and the long side walls 10 of pan 3.

As explained above, heating rods 5, which preferably are composed of graphite, are held in support rings 6. The latter are rectangular and have an inner opening 11 matched to the cross section of heating rods 5, through which inner opening the end of a heating rod 5 passes. The outside edge of support rings 6 is provided with an encompassing groove 12 which is approximately as wide as the sheet is thick from which pan 3 and lid 8 are produced. Heating rods 5 are set upon pan 3 with pan edge 9 being introduced into grooves 12 of support rings 6.

Lid 8 depicted next to pan 3 has the shape of a house with a gable roof, i.e. it has two rectangular side walls 13, two roof slopes 14 and two gable walls 15. In the ridge of the gable roof, roof slopes 14 come together up to a slot which functions as exit slot 16 for the vapor generated in the housing.

Side walls 13 of lid 8 are approximately as high as support ring 6 and have corresponding rectangular cutouts 17 open to the edge so that when the lid is in place, the edge of cutouts 17 is submerged in groove 12 on support rings 6. Thus when lid 8 is in place a closed housing is obtained through which three heating rods 5 pass transversely and which at the upper side has an exit slot 16 for the exit of generated vapor.

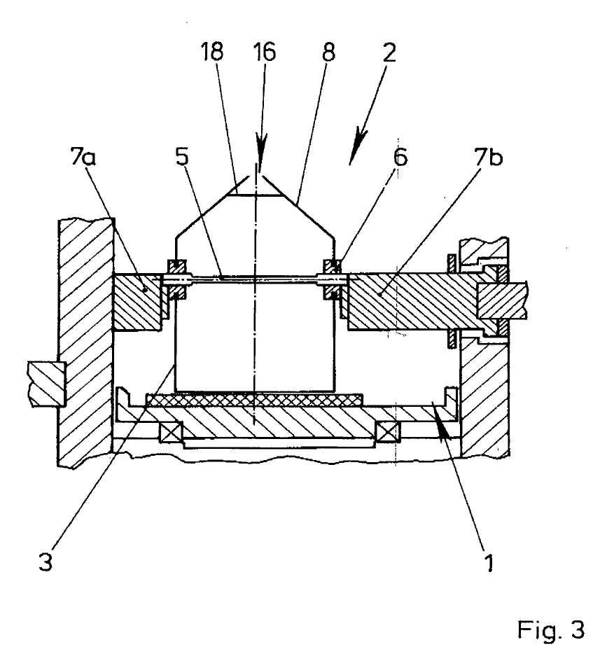

In order to make this clear once again, FIG. 3 shows a cross section through vaporization arrangement 2. The contour of the housing formed by a pan 3 and a lid 8 corresponds in cross section to a rectangle onto the short side of which a triangle is set. In the upper third of the rectangular housing area, heating rods 5, which are rectangular in cross section and the flat side of which is directed downward, pass through the housing. In FIG. 3, a fixed contact post 7a for contacting the projecting end of heating rod 5 can be seen. On the other side, a movable contact post 7b is situated which contacts the other end of heating rod 5 which projects out of the housing. Above the contact posts, heating rod 5 is connected to a power supply. It heats up as a result of the current flowing through, whereby its heat energy is given off in the form of radiant output in particular to the material 4 situated in pan 3, which material then vaporizes.

In the gable of lid 8 are also situated perforated covering sheets 18 which while they allow passage of the vapor, they prevent material fragments from being carried out into vaporization space 1.

### Reference List

1 Vaporization space
2 Vaporization arrangement
3 Pans
4 Material
5 Heating rod
6 Support ring
7 Contact post
8 Lid
9 Edge
10 Side wall
11 Inner opening
12 Groove
13 Side walls
14 Roof slopes
15 Gable walls
16 Exit slot
17 Cutouts open to the edge
18 Covering sheet

1. Vaporization arrangement, in particular for use in a vacuum coating system for film with at least one pan (3) for receiving the material (4) to be vaporized and a heating device comprising radiant heaters, characterized in that the radiant heaters are configured as heating rods (5) that are situated above the pan (3).

2. Vaporization arrangement according to claim 1 characterized in that situated on the pan (3) is a lid (8) that is provided with an exit slot (16) for the vaporized material, with the heating rod (5) being situated in the housing formed by the lid (8) and the pan (3).

3. Vaporization arrangement according to claim 1 characterized in that the housing is longer than wide and that in the longitudinal direction several heating rods (5) are present arranged transverse to the longitudinal dimension of the pan (3)

4. Vaporization arrangement according to claim 1 characterized in that each heading rod (5) is held on both sides in a support ring (6) of high-temperature ceramic.

5. Vaporization arrangement according to claim 1 characterized in that the support rings (6) rests on the pan rim (9) and projects into corresponding cutouts (17) open to the edge in the lid (8) or the pan (3).

6. Vaporization arrangement according to claim 1 characterized in that the faces of the heating rods (5) project latterly out of the housing.

7. Vaporization arrangement according to claim 1 characterized in that the heating rods (5) are configured flat, preferably with a rectangular cross section, with the flat side being directed toward the pan (3).

8. Vaporization arrangement according to claim 1 characterized in that the support rings (6) are provided with an encompassing groove (12) in which the edges of the pan (3) or of the lid (8) submerge.
